(19) United States
(12) Patent Application Publication
(10) Pub. No.: US 2017/0188120 A1
(43) Pub. Date: Jun. 29, 2017

(54) Method and electronic device for producing video highlights

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventor: Boyuan LIU, Beijing (CN)

(21) Appl. No.: 15/240,178

(22) Filed: Aug. 18, 2016

Related U.S. Application Data
(63) Continuation of application No. PCT/CN2016/088785, filed on Jul. 6, 2016.

(30) Foreign Application Priority Data
Dec. 29, 2015 (CN) 2015110243610

(51) Int. Cl. H04N 21/8549; H04H 60/46; H04N 21/2668; G11B 27/031; H04N 21/258; H04H 60/33; H04N 21/442

(52) U.S. Cl. CPC H04N 21/8549; H04H 60/33; H04H 60/46; H04N 21/44218; G11B 27/031; H04N 21/25891; H04N 21/2668

(57) ABSTRACT

Embodiments of the disclosure disclose a method, an electronic device and a non-transitory computer-readable storage medium for producing a video highlights. The method for producing a video highlights includes: capturing a viewing response of a user when viewing video, wherein, the viewing response is an indirect user response with respect to user directly-clipped video; obtaining a video segment corresponding to the viewing response; and producing a first video highlights document based on the video segment. In addition, the method may further include: setting at least one video interval in the video; when the video segment overlaps a video interval of the at least one video interval, increasing a score of the video interval; and producing a second video highlights document based on the score and the at least one video interval.

### CROSS REFERENCE TO RELATED APPLICATIONS

This application is a continuation of International Application No. PCT/CN2016/088785 filed on Jul. 6, 2016 which is based upon and claims priority to Chinese Patent Application NO. 201511024361.0, titled “Method, Device, Electronic Equipment, Server and System for Producing Video highlights”, filed with the Chinese Patent Office on Dec. 29, 2015, the entire contents of which are incorporated herein by reference.

### TECHNICAL FIELD

The disclosure relates to video processing, and particularly to a method for producing a video highlights, an electronic device and a non-transitory computer-readable storage medium.

### BACKGROUND

As discovered by the inventor in carrying out the disclosure: generally speaking, when browsing video such as a teleplay or a film or the like, a user can only manually adjust a progress bar continuously through a remote controller, a mouse, a touch screen and the like, so as to view a certain segment in the video.

With the development of network technology, more and more video has been propagated over a network, and a user can also propagate information using a network. However, the inventor of the disclosure has realized some defects existing in the prior art.

Firstly, when viewing a network teleplay or a film, a user desires to intuitively browse excellent segments of the film, so as to judge whether the film satisfies his/her own taste. However, the user shall adjust a progress bar continuously since he absolutely has no idea about contents to be viewed. This manner would render poor pertinence and low efficiency.

Secondly, after finishing viewing of the teleplay or the film, the user desires to review excellent segments therein. In the prior art, before performing viewing, the user shall adjust a progress bar continuously, so as to search for segments of his/her own interest. Such a searching operation is performed repeatedly until the end of the film. This manner would also render low efficiency.

For an excellent sement, the user can set a playback video interval directly. However, this manner requires relatively complicated operations. On the one hand, this manner requires the user to manually perform setting, which would possibly interrupt continuity of the user viewing of the video. On the other hand, this manner would render relatively poor user experience.

Hence, the inventor of the disclosure has realized that a new technical solution shall be provided, so as to reduce user operations, and/or improve user efficiency, and/or provide a more pertinent video highlights. The video highlights herein may include at least one video sement.

### SUMMARY

In view of the foregoing defects, the disclosure is proposed to provide a method, an electronic device and a non-transitory storage medium for producing a video highlights which overcome the foregoing defects or at least partially solve the foregoing defects.

According to a first aspect of embodiments of the disclosure, there is provided a method for producing a video highlights, including: capturing a viewing response of a user when viewing video, wherein, the viewing response is an indirect user response with respect to user directly-clipped video; obtaining a video segment corresponding to the viewing response; and producing a first video highlights document based on the video segment.

According to a second aspect of embodiments of the disclosure, there is provided an electronic device, including: at least one processor; and a storage which is communicated with the at least one processor. The storage stores instructions that can be executed by one processor and the at least one processor executes the instructions and then enable the at least one processor to: capture a viewing response of a user when viewing video, wherein, the viewing response is an indirect user response with respect to user directly-clipped video; obtain a video segment corresponding to the viewing response; and produce a first video highlights document based on the video segment.

According to a third aspect of the disclosure, there is provided a non-transitory computer-readable storage medium which stores executable instructions by a computer, the executable instructions by the computer are set to: capture a viewing response of a user when viewing video, wherein, the viewing response is an indirect user response with respect to user directly-clipped video; obtain a video segment corresponding to the viewing response; and produce a first video highlights document based on the video segment.

As discovered by the inventor of the disclosure: in the prior art, there is not yet a solution of producing a video highlights according to a natural viewing response of a user. In the disclosure, however, a video highlights is produced by capturing a viewing response of a user, thus avoiding troublesome manual operations of the user, making it possible to bring a better use experience to the user. Hence, the technical task to be carried out or the technical problem to be solved by the disclosure is never considered or expected by a person skilled in the art, so the disclosure constitutes a new technical solution.

The foregoing descriptions are only a summary of the technical solution of the disclosure. To enable more clear understanding to the technical means of the disclosure, the technical means can be implemented in accordance with the disclosure of the description, and to make the foregoing and other objects, features and advantages of the disclosure more obvious and pellucid, specific embodiments of the disclosure are listed below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a block diagram showing an example that can be used for implementing configuration of an electronic device of an embodiment of the disclosure.

FIG. 2 illustrates a flow chart of a method for producing a video highlights according to an embodiment of the disclosure.

FIG. 3 illustrates a block diagram of a producing device of a video highlights according to an embodiment of the disclosure.

FIG. 4 illustrates a block diagram of a server according to an embodiment of the disclosure.

FIG. 5 illustrates a schematic view of a system for producing a video highlights according to an embodiment of the disclosure.

FIG. 6 schematically illustrates hardware structure of devices for producing a video highlights according to the embodiment of the disclosure.

### DETAILED DESCRIPTION

Hereinafter, exemplary embodiments of the disclosure will be described in more detail with reference to the accompanying drawings. Although the exemplary embodiments of the disclosure are shown in the accompanying drawings, it should be understood that the disclosure can be realized in various forms, which should not be limited by the embodiments disclosed herein. Instead, the embodiments are provided to enable more thorough understanding to the disclosure, and to enable a person skilled in the art to get acquaintance to the whole scope of the disclosure.

<Configuration of Electronic Device>

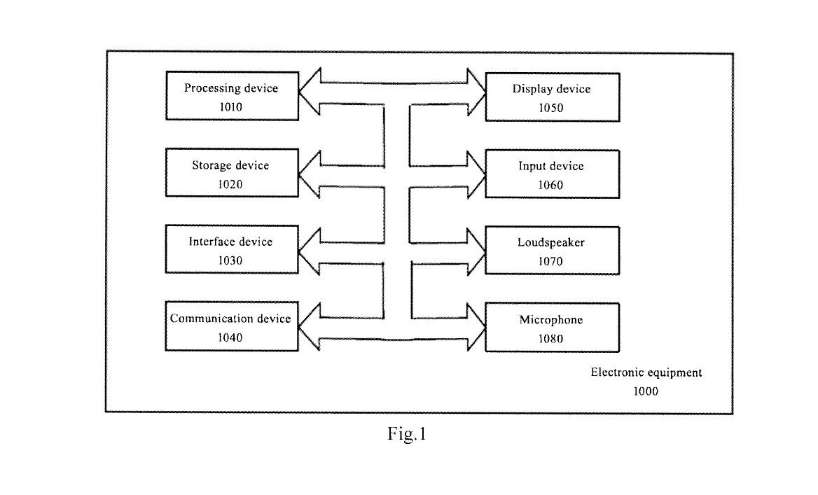

FIG. 1 is a block diagram showing an example that can be used for implementing configuration of an electronic device 1000 of an embodiment of the disclosure.

The electronic device 1000 for example may be a cell phone, a tablet computer, a network TV, a set-top box, and the like.

As shown in FIG. 1, the electronic device 1000 includes a processing device 1010, a storage device 1020, an interface device 1030, a communication device 1040, a display device 1050, an input device 1060, a loudspeaker 1070, a microphone 1080, etc.

The processing device 1010 for example may be a central processor CPU, a micro-processor MCU, and the like. The storage device 1020 for example includes an ROM (Read-Only Memory), an RAM (Random Access Memory), a non-transitory memory such as a hard disk, and the like. The intefface device 1030 for example includes a USB interface, an earphone interface, and the like.

The communication device 1040 for example can perform wired or wireless communication.

The display device 1050 for example is a liquid crystal display screen. The input device 1060 for example may include a touch screen, a keyboard and the like. A user can input/output speech information through the loudspeaker 1070 and the microphone 1080.

The electronic device as shown in FIG. 1 is only explanatory, and does not aim to limit the disclosure and the application or use thereof at all. By using the electronic device as shown in FIG. 1, the embodiment of the disclosure can capture a viewing response of a user conveniently, so as to produce a video highlights automatically according to the captured viewing response of the user, thus avoiding troublesome manual operations of the user while producing no influence on the effect of user viewing of the video, and making it possible to bring a better use experience to the user.

### Embodiments

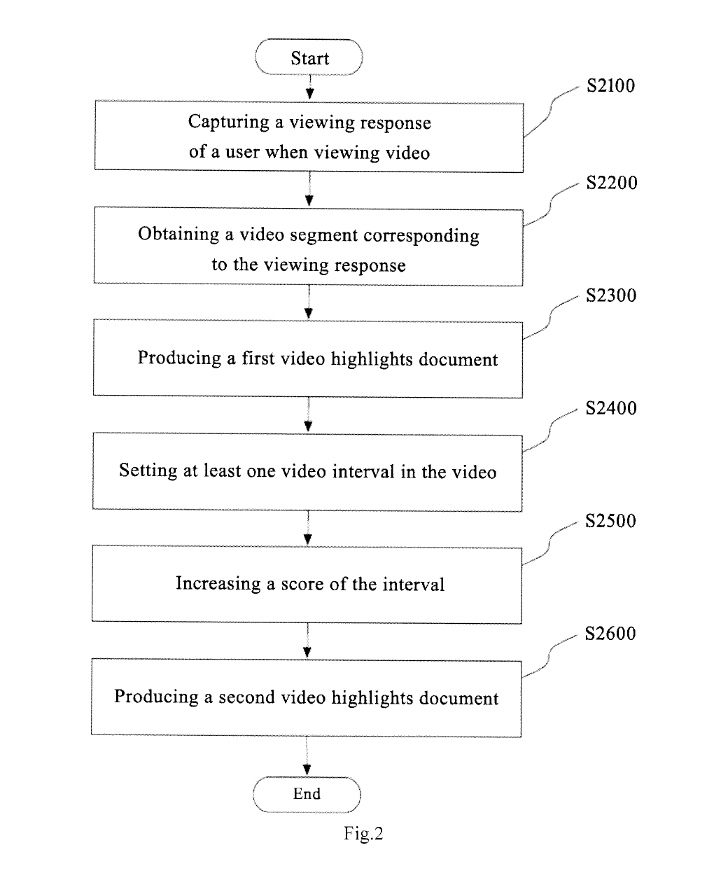

FIG. 2 illustrates a flow chart of a method for producing a video highlights according to an embodiment of the disclosure.

As shown in FIG. 2, in step S2100, a viewing response of a user when viewing video is captured, wherein, the viewing response is an indirect user response with respect to user directly-clipped video.

This indirect viewing response is a natural response of the user in the video viewing process of the user. With respect to a direct clip operation such as setting a start time and an end time of a segment and so on, it produces a relatively slight influence on the viewing process of the user. In the disclosure, it is unnecessary for the user to initiatively intervene in video editing.

For example, the viewing response may be at least one of user sound, a user facial expression and a user playback operation. For example, the user sound is user laughter. The user response can be collected through a microphone or a video camera or the like. A person skilled in the art would appreciate how to collect the user response, and the disclosure does not focus on specific collecting manners, so no more description will be made in detail herein.

In step S2200, a video segment corresponding to the viewing response is obtained.

The video segment can be determined based on a time point of capturing the viewing response. In one example, a time point of capturing the viewing response is used as a time midpoint of the video segment. A length of the video may be 4 minutes. In this case, video contents within 2 minutes prior to the time midpoint and 2 minutes after the time midpoint are used as the video segment.

In step S2300, a first video highlights document is produced based on the video segment.

The first video highlights document may be an intercepted video segment per se, and may also be a configuration document that records a time point, or a combination of the two. For example, the first video highlights document may include a configuration document for recording a start time and an end time of the video segment directly or indirectly.

The user can obtain a video segment which relatively have pertinence, based on the first video highlights document.

In addition, in the disclosure, by acquiring an indirect response of the user, it is made unnecessary for the user to directly clip video, which would not hinder the viewing process of the user. Hence, the solution of the disclosure can bring better experience to the user.

Alternatively, the disclosure also provides further improvements. In the case of a plurality of users viewing the same video, an improved video highlights can be provided while considering responses of these users comprehensively. This is particularly advantageous in a case where the video is shared over a network. For example, the disclosure alternatively may further include steps S2400-S2600, as shown in FIG. 2.

In step S2400, at least one video interval is set in the video. For example, a video interval is divided in the video every 5 minutes.

In step S2500, when the video segment overlaps a video interval of the at least one video interval, a score of the video interval is increased.

For example, the overlapping can be determined based on the first video highlights document.

For example, a portion of the video segment which overlaps the video interval occupies at least 60% of the video segment.

For example, the score can be increased by 1 each time. In this way, the number of users showing interest in the interval can be recorded.

In step S2600, a second video highlights document is produced based on the score and the at least one video interval.

For example, a plurality of video intervals with the highest score is selected to produce the second video highlights document.

In one example, the score is increased by 1 each time. In this case, video intervals covered in the second video highlights document can be determined based on a ratio of the score to the total number of users sharing the video. For example, video intervals with the ratio greater than 70% can be used to produce the second video highlights document.

Similarly, the second video highlights document may be an intercepted video segment per se, and may also be a configuration document that records a time point, or a combination of the two.

The method as shown in FIG. 2 may be implemented in an electronic device at a terminal, and may also be implemented at a server end, or may be implemented by a combination of the two.

According to the method for producing a video highlights as provided by the embodiment of the disclosure, a video highlights is produced automatically by capturing a viewing response of a user, thus avoiding troublesome manual operations of the user while producing no influence on the effect of user viewing of the video, and making it possible to bring a better use experience to the user.

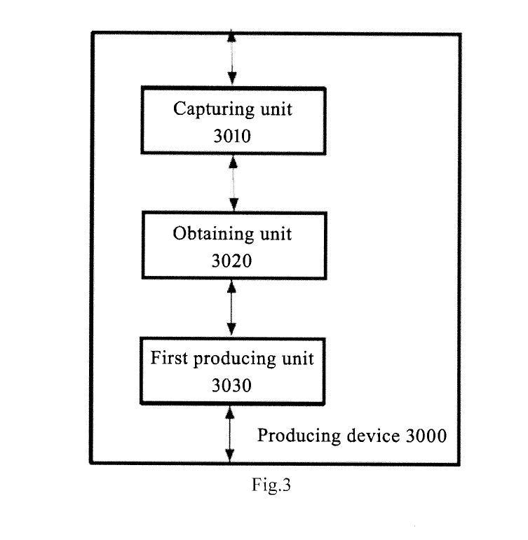

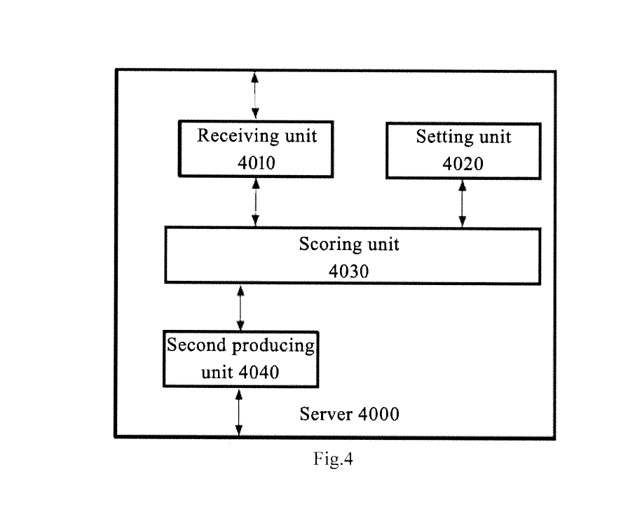

FIG. 3 illustrates a block diagram of a producing device 3000 of a video highlights according to an embodiment of the disclosure. The producing device 3000 includes a capturing unit 3010, an obtaining unit 3020 and a first producing unit 3030.

The capturing unit 3010 is set to capture a viewing response of a user when viewing video, wherein, the viewing response is an indirect user response with respect to user directly-clipped video.

For example, the viewing response is at least one of user sound, a user facial expression and a user playback operation. For example, the user sound is user laughter.

The obtaining unit 3020 is set to obtain a video segment corresponding to the viewing response.

In one example, the obtaining unit 3020 is set to use a time point of capturing the viewing response as a time midpoint of the video segment. For example, a length of the video is 4 minutes.

The first producing unit 3030 is set to produce a first video highlights document based on the video segment.

For example, the first video highlights document includes a configuration document for recording a start time and an end time of the video segment directly or indirectly.

As would be appreciated by a person skilled in the art, the respective units in the producing device 3000 can be realized in various manners. For example, the respective units can be realized by an instruction configuration processor. For example, an instruction can be stored in an ROM, and upon startup of the device, the instruction is read from the ROM to a programmable device to realize the respective units. For example, the respective units can be solidified to a dedicated device (e.g. an ASIC). The respective units can be divided into units independent of each other, or can be combined together to be realized. The units can be realized in one of the foregoing various realization manners, or can be realized by a combination of two or more of the respective realization manners. For a person skilled in the art, all of these realization manners are equivalent.

In one example, the producing device 3000 can be arranged in an electronic device. For example, the electronic device is the electronic device 1000 as shown in FIG. 1. When viewing video using the electronic device, the user can produce the first video highlights document using the producing device 3000.

According to the producing device of a video highlights as provided by the embodiment of the disclosure, a video highlights is produced automatically by capturing a viewing response of a user, thus avoiding troublesome manual operations of the user while producing no influence on the effect of user viewing of the video, and making it possible to bring a better use experience to the user.

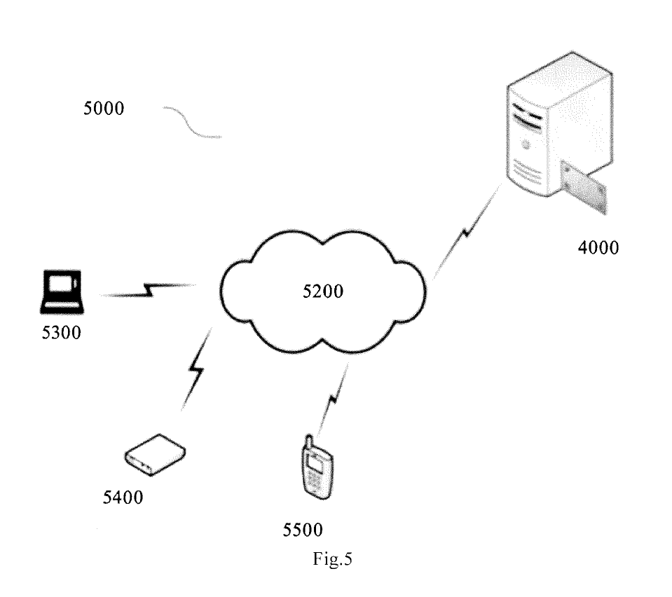

FIG. 4 illustrates a block diagram of a server 4000 according to an embodiment of the disclosure.

The server 4000 includes a receiving unit 4010, a setting unit 4020, a scoring unit 4030 and a second producing unit 4040.

The receiving unit 4010 is set to receive a configuration document, wherein, the configuration document is used for recording a start time and an end time of the video segment directly or indirectly.

The setting unit 4020 is set to set at least one video interval in the video.

The scoring unit 4030 is set to, when the video segment overlaps a video interval of the at least one video interval, increase a score of the video interval.

For example, a portion of the video segment which overlaps the video interval occupies at least 60% of the video segment.

The second producing unit 4040 is set to produce a second video highlights document based on the score and the at least one video interval.

Similarly, the respective units in the server 4000 may also be realized by software, hardware, or a combination of software and hardware. A person skilled in the art would appreciate that the realization manners of software and hardware are actually equivalent.

According to the server as provided by the embodiment of the disclosure, by scoring video intervals, video segments of the user's interest can be better selected, and they are applied to production of a video highlights, thus avoiding troublesome manual operations of the user while producing no influence on the effect of user viewing of the video, and making it possible to bring a better use experience to the user.

FIG. 5 illustrates a schematic view of a system 5000 for producing a video highlights according to an embodiment of the disclosure. The system 5000 includes electronic devices 5300, 5400 and 5500 and the server 4000. The electronic devices 5300, 5400 and 5500 communicate with the server 4000 over a network 5200. The electronic devices 5300, 5400 and 5500 for example include the producing device 3000 as shown in FIG. 3. The server 4000 for example is the server as shown in FIG. 4.

The electronic devices 5300, 5400 and 5500 for example may be cell phones, tablet computers, computers, set-top boxes, TVs, and the like.

Any one or more of the electronic devices 5300, 5400 and 5500 are used for sending a first video highlights document to the server 4000. The server 4000 is used for using the first video highlights document as a configuration document, so as to produce a second video highlights document.

According to the system for producing a video highlights as provided by the disclosure, a video highlights is produced automatically by capturing a viewing response of a user, thus avoiding troublesome manual operations of the user while producing no influence on the effect of video viewing of the user, and making it possible to bring a better use experience to the user.

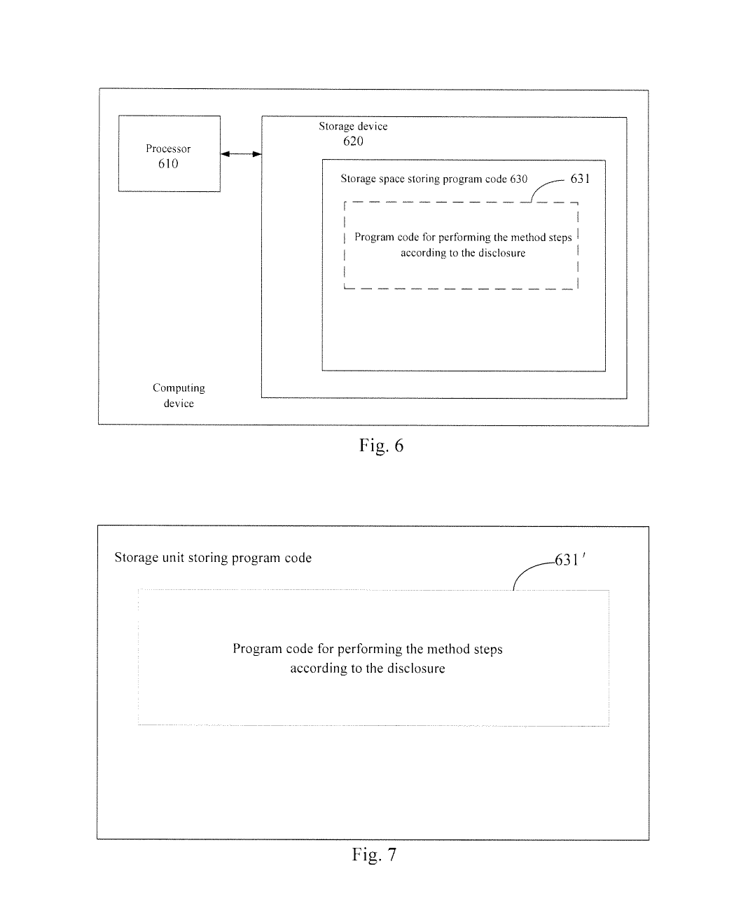

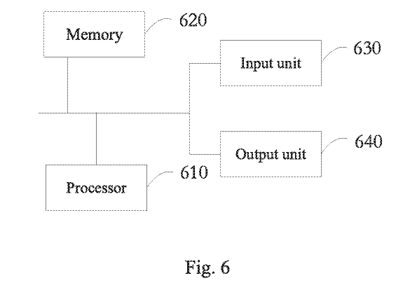

FIG. 6 schematically illustrates hardware structure of devices for producing a video highlights according to the embodiment of the disclosure. As illustrated in FIG. 6, the device include: one or more processor 610 and a memory 620. One processor 610 is taken as example in FIG. 6.

The devices for producing video highlights may further include: input unit 630 and output unit 640.

The processor 610, the memory 620, input unit 630 and output unit 640 can be connected to each other through BUS or other methods, and BUS connecting is taken for an example in FIG. 6. As a non-transitory computer-readable storage medium, the memory 620 is used for storing non-transitory software program, non-transitory computer executable program and module, such as program instruction/module used for performing the method for producing video highlights according to embodiment of the disclosure (such as shown in FIG. 3, a capturing unit 3010, an obtaining unit 3020 and a first producing unit 3030, and shown in FIG. 4, a receiving unit 4010, a setting unit 4020, a scoring unit 4030 and a second producing unit 4040). The processor 610 performs various function applications and data processing through executing non-transitory software program, instruction and module stored in the memory 620, to realize various performing methods shown in the embodiments.

The memory 620 possesses program storage space and date storage space. The program storage space is for storing operating system and application program for performing at least one function; date storage space is to store the data created upon using the processing device used in producing video highlights. Furthermore, memory 620 can include high speed Random-access memory (RAM) or non-volatile memory such as magnetic disk storage device, flash memory device or other non-volatile solid state storage devices. In some embodiments, memory 620 can include long-distance setup memories relative to processor 610, which can communicate with the device for producing video highlights by networks. The examples of said networks are including but not limited to Internet, Intranet, LAN, mobile Internet and their combinations.

Input unit 630 can be used to receive inputted number, character information and key signals causing user configures and function controls of the device for producing video highlights. Output unit 640 can include a display screen or a display device.

The said module or modules are stored in memory 620 and perform the methods for playing live video when executed by one or more processors 610.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile intern& function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-18. (canceled)

19. A method for producing a video highlights, which is applied to terminals, including:
capturing a viewing response of a user when viewing video, wherein, the viewing response is an indirect user response with respect to user directly-clipped video;
obtaining a video segment corresponding to the viewing response; and
producing a first video highlights document based on the video segment.

20. The method according to claim 19, wherein, the viewing response is at least one of user sound, a user facial expression and a user playback operation.

21. The method according to claim 20, wherein, the user sound is user laughter.

22. The method according to claim 19, wherein, a time point of capturing the viewing response is used as a time midpoint of the video segment.

23. The method according to claim 19, wherein, the first video highlights document includes a configuration document for recording a start time and an end time of the video segment directly or indirectly.

24. The method according to claim 19, further including:
setting at least one video interval in the video;
when the video segment overlaps a video interval of the at least one video interval, increasing a score of the video interval; and
producing a second video highlights document based on the score and the at least one video interval.

25. The method according to claim 24, wherein, a portion of the video segment which overlaps the video interval occupies at least 60% of the video segment.

26. An electronic device, including:
at least one processor; and
a storage which is communicated with the at least one processor.
The storage stores instructions that can be executed by one processor. The instructions are executed by the at least one processor and then enable the at least one processor to:
capture a viewing response of a user when viewing video, wherein, the viewing response is an indirect user response with respect to user directly-clipped video;
obtain a video segment corresponding to the viewing response; and
produce a first video highlights document based on the video segment.

27. The electronic device according to claim 26, wherein, the viewing response is at least one of user sound, a user facial expression and a user playback operation.

28. The electronic device according to claim 27, wherein, the user sound is user laughter.

29. The electronic device according to claim 26, wherein, the processor further performs: using a time point of capturing the viewing response as a time midpoint of the video segment.

30. The electronic device according to claim 26, wherein, the first video highlights document includes a configuration document for recording a start time and an end time of the video segment directly or indirectly.

31. The electronic device according to claim 26, wherein, the processor further performs that:
at least one video interval is set in the video,
when the video segment overlaps a video interval of the at least one video interval, a score of the video interval is increased, and
a second video highlights document is produced based on the score and the at least one video interval.

32. A non-transitory computer-readable storage medium, which stores executable instructions by a computer, the executable instructions by the computer are set to:
capture a viewing response of a user when viewing video, wherein, the viewing response is an indirect user response with respect to user directly-clipped video;
obtain a video segment corresponding to the viewing response; and
produce a first video highlights document based on the video segment.

33. The non-transitory computer-readable storage medium according to 32, wherein, the viewing response is at least one of user sound, a user facial expression and a user playback operation.

34. The non-transitory computer-readable storage medium according to 33, wherein, the user sound is user laughter.

35. The non-transitory computer-readable storage medium according to 32, wherein, the executable instructions by the computer are set to use a time point of capturing the viewing response as a time midpoint of the video segment.

36. The non-transitory computer-readable storage medium according to 32, wherein, the first video highlights document includes a configuration document for recording a start time and an end time of the video segment directly or indirectly.

37. The non-transitory computer-readable storage medium according to 32, wherein, the executable instructions by the computer are set to:
set at least one video interval in the video;
increase a score of the video interval when the video segment overlaps a video interval of the at least one video interval; and
produce a second video highlights document based on the score and the at least one video interval.

38. A non-transitory computer-readable storage medium according to 37, wherein, a portion of the video segment which overlaps the video interval occupies at least 60% of the video segment.
